(19) United States
(12) Patent Application Publication
(10) Pub. No.: US 2019/0013715 A1
(43) Pub. Date: Jan. 10, 2019

(54) BRAKE FOR ROTARY ELECTRIC MACHINE

(71) Applicant: MOTEURS LEROY-SOMER, Angouleme (FR)

(72) Inventors: Pascal CARRIOT, La Couronne (FR); Benoît VINCENT, Champniers (FR); Joël MAYSOUNABE, Dirac (FR); Pascal BEYNAUD, Saint Saturnin (FR)

(73) Assignee: MOTEURS LEROY-SOMER, Angouleme (FR)

(21) Appl. No.: 16/065,866

(22) PCT Filed: Dec. 14, 2016
(86) PCT No.: PCT/EP2016/080969

§ 371 Date: Jun. 25, 2018

(30) Foreign Application Priority Data
Dec. 23, 2015 (FR) 1563253

(51) Int. Cl. H02K 7/102; F16D 59/00; F16D 55/02

(52) U.S. Cl. CPC H02K 7/1025; F16D 2121/22; F16D 55/02; F16D 59/00

(57) ABSTRACT

A brake for a rotary electric machine including a rotor having a shaft, the brake including: at least one fixed armature; at least one yoke that can be moved between a position of braking the shaft of the machine and a position in which the shaft rotates freely; at least one coil borne by the yoke; at least one brake disc borne by the shaft of the rotor; at least one elastic return system for applying the yoke against the brake disc in the absence of electrical excitation of the coil, the armature being positioned such that the excitation of the coil causes the yoke to approach the armature and distances the yoke from the brake disc.

The present invention relates to brakes for electric motors.

In some uses, such as lifting or driving elevator cars, the motors are provided with a zero-current brakes, which block the motor rotor when they are no longer electrically powered.

These brakes conventionally include a yoke fixed with respect to the casing of the motor, which houses a winding, and a mobile armature which can be moved under the effect of a magnetic field generated by the winding. Return springs exert a pushing force on the armature in order to hold it in the position for locking the rotor when the winding is not powered. In order to unclamp the brake, a current is sent into the winding, which moves the armature away from the blocking position thereof, against the return action of the springs.

For safety reasons, the motors are often provided with several redundant brakes. The brakes are thus stacked axially or placed side-by-side on either side of the rotor shaft.

DE 7146345 discloses a brake including a mobile armature.

EP 1 715 564 A2 discloses a motor provided with two brakes, each in caliper form, with two mobile armatures and two fixed yokes which are independent.

EP 1 883 756 A2 describes a motor provided with two independent brakes, each with a mobile armature and a fixed yoke. The yokes have a rectangular shape, and the windings have an elliptical or annular shape.

Known brakes prove to be relatively noisy.

There is a need to derive benefit from a brake that is easy to install on an electric motor, with reliable operation, reduced spatial requirement and little noise.

The invention achieves this objective thanks to a brake for a rotary electric machine, including a rotor having a shaft, the brake including:
at least one fixed armature,
at least one yoke mobile between a position for braking the shaft of the machine and a position for free rotation of the shaft,
at least one winding borne by the yoke,
at least one brake disc borne by the rotor shaft,
at least one elastic return system for applying the yoke against the brake disc in the absence of electrical excitation of the winding, the armature being placed such that the excitation of the winding causes the yoke to draw closer to the armature and moves the yoke away from the brake disc.

The fact that the yoke is mobile, in the invention, tends to reduce the operating noise since the yoke with the winding thereof has more mass than the armature. The speed of the yoke is less since it takes longer to accelerate. The brake may use a single disc, which makes it possible to reduce the weight and the spatial requirement.

Preferably, the elastic return system is inserted between the armature and the yoke. For example, it is made up by several helical springs. These springs may be housed in the thickness of a wall of the yoke which defines the housing receiving the winding. When this housing has an elongated shape, the springs are preferably placed along the long sides of the yoke. The springs are advantageously received in blind holes of the yoke.

Preferably, the yoke is open in the direction of the armature. This makes it possible to more easily arrange, on the yoke, a surface suitable for contacting the brake lining of the brake disc.

To make it possible to manually actuate the brake in the absence of current, an operating lever may be supplied in order to act on the yoke through the armature, being for example engaged under a screw head fixed on the yoke and jutting out from the armature in the opposite direction to the casing of the motor. This lever can, when it is actuated, bear on the armature, particularly via a plate with which it is rigidly connected at the base thereof, in order to pull on the yoke.

The armature may substantially have the same outer contour as the yoke. The armature and/or the yoke may particularly have a substantially polygonal contour. Preferably, the winding has an elongated shape.

The yoke is preferably a casting, which makes it possible to produce it at a lesser cost. The same applies to the armature.

The armature may bear removable plugs which face housings of the yoke that may receive compression additional springs of the elastic return system, thus making it possible to increase the braking torque without having to dismantle the brake.

Another object of the invention is a rotary electric machine including at least one brake according to the invention, as defined above.

It is particularly advantageous that there is more than one brake, preferably a double brake, i.e. the machine includes at least two identical brake units placed on either side of the axis of the rotor. In an alternative, the brake includes several yokes, particularly two yokes placed on either side of the axis of the rotor, and an armature that is common to the yokes. Such an armature may include two parts placed on either side of the axis of the rotor, which are connected by material bridges, preferably consisting of one piece with said parts. Each part of the armature is associated with a corresponding yoke.

The or each brake may have the armature thereof fixed to the casing of the machine by screws and struts between which and/or on which the corresponding yoke moves.

Preferably, damping elements are inserted between the yoke and the casing on the one hand, and the yoke and the armature on the other hand. These damping elements are preferably made up by rings made from an elastically deformable material, such as an elastomer, which are engaged on the struts. In some known brakes, the damping element is made up by an O-ring placed between the yoke and the armature.

The invention is used for any rotary electric machine, but is particularly suitable for those for which the rotor drives a winch or a pulley.

Preferably, the brake disc is axially mobile on the shaft of the machine, thanks to a splined connection for example.

The invention will be able to be better understood upon reading the following detailed description, of nonlimiting examples for implementing the invention, and upon examining the appended drawing, wherein:

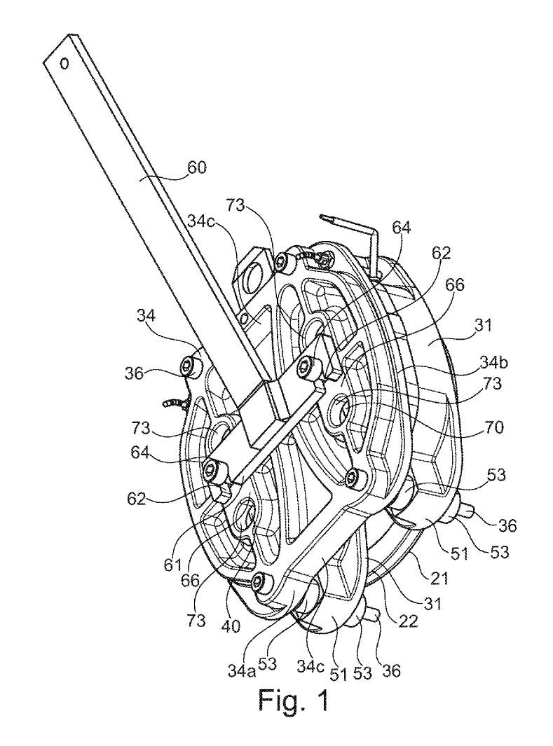

FIG. 1 shows, in isolation and in perspective, a brake produced in accordance with a first example for implementing the invention,

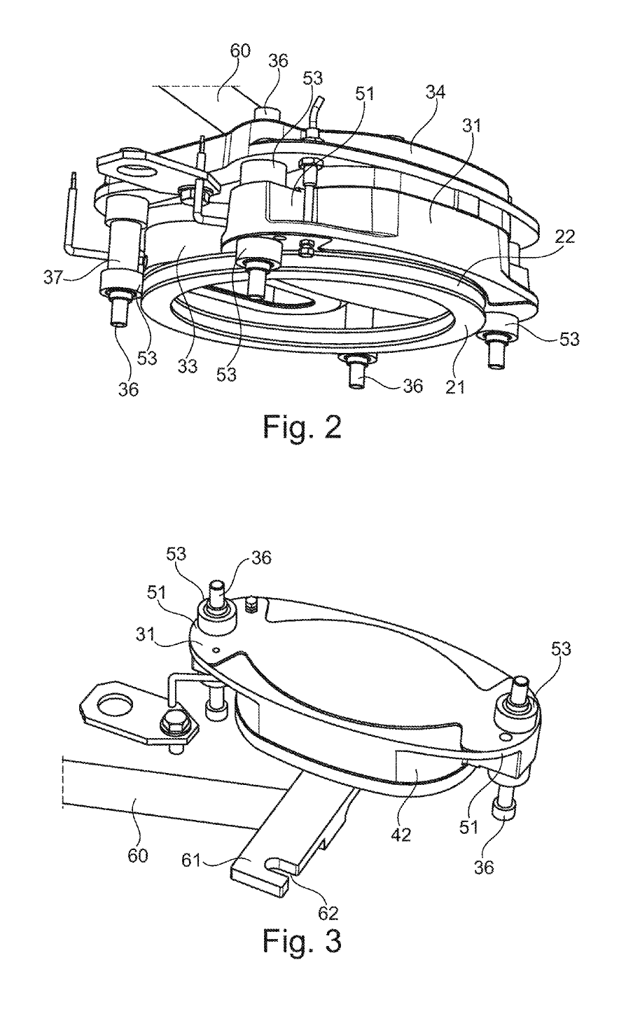

FIG. 2 shows the brake of FIG. 1 from another viewing angle, after removing some components, particularly the yoke of one of the brake units,

FIG. 3 partially and schematically shows, in perspective, the brake of FIG. 1 with some components removed, particularly the armature,

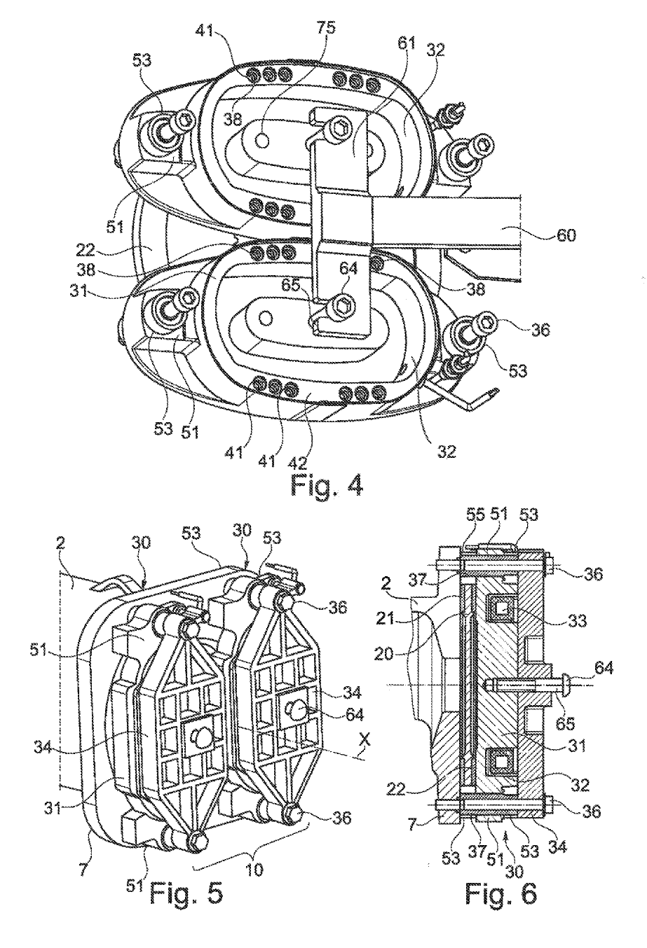

FIG. 4 is another partial and schematic view of the brake of FIG. 1, with the armature and winding removed,

FIG. 5 schematically and partially shows, in perspective, an example of a motor provided with a second brake example according to the invention, and

FIG. 6 is a schematic axial section of a brake unit of FIG. 5.

FIGS. 1 to 4 show a brake 10 in accordance with the first example for implementing the invention. This brake 10 is intended to be provided on an electric motor which is not shown in the figures, including a rotor rotating with a shaft relative to a casing on which the brake is fixed.

The rotor may be wound and/or have permanent magnets or have a squirrel cage.

The shaft rotates a brake disc which bears brake linings 21 and 22. The brake disc is connected to the shaft by a splined connection, which allows it to transmit the braking torque to the shaft while being able to move axially with respect thereto.

In the example of FIGS. 1 to 4, the brake 10 includes two identical brake units 30, which share a common armature 34, divided into two parts 34a and 34b connected by material bridges 34c. The parts 34a and 34b are associated with the brake units 30, respectively.

Each brake unit 30 includes a yoke 31 which has a housing 32 open on the opposite side to the housing.

A winding 33 with an elongated shape is received in the housing 32. The yoke 31 is, for example, produced from magnetic cast iron. In an alternative, the yoke 31 is produced with a stack of assembled magnetic laminations, like the rotor or stator lamination stacks that are conventionally used.

The armature 34 is fixed on the casing of the machine using screws 36 and struts 37.

Each yoke 31 is located between the armature 34 and the casing, and it is made to bear against the casing by compression springs 38, which may be seen in FIG. 4.

These springs 38 are housed in blind holes 41 machined in the peripheral wall 42 of the yoke 31, which laterally defines the housing 32. For example, there are twelve springs 38 for each yoke 31, being split into two groups of three along the long sides of the yoke 31.

Thus, when the winding 33 is not electrically powered, the yoke 31 is pressed against the brake disc by the springs 38, and the brake disc is pushed against the housing. The brake linings 21 and 22 are thus applied against the casing and the yoke 31, respectively, and the rotor is locked against rotation. The brake is said to be a “zero current brake”, since it exerts the braking action thereof when the electrical powering of the winding is cut off. The yokes 31 are applied against the brake disc on either side of the axis of rotation thereof.

When the winding 33 is electrically powered, the yoke 31 moves closer, via magnetic attraction, to the armature 34 and moves away from the brake disc 20, which is released and may again rotate freely.

The yoke 31 has extensions 51 at the longitudinal ends thereof, through which the struts 37 pass, as may be seen in FIG. 2 in particular.

Damping elements made up by rings 53 made from an elastically deformable material are mounted on each strut 37 on either side of the corresponding extension 51. One of the rings 53 is thus inserted axially between the yoke 31 and the armature 34 and the other ring 53 is inserted between the yoke 31 and the casing 7.

These rings 53 do not prevent the axial movement of the yoke 31 between the braking and free rotation positions, but make it possible to dampen the movement of the yoke at the end of travel and to even further reduce the operating noise.

To make it possible to maneuver the brake manually in the absence of electrical powering of the windings 33, a lever 60, which may be seen particularly in FIG. 3, is supplied.

This lever 60 includes, at the base thereof, a plate 61 provided with two openings 62 making it possible to engage it between the screw 65 head 64 and the outer face 66 of the armature 34.

The screws 65 are each fixed in a corresponding yoke 31, as may be seen in particular in FIG. 4, and pass through the armature 34 thanks to borings of sufficient diameter.

When the operator wishes to release the brake 10, the latter pushes on the lever 60. The plate 61 bears on the outer face 66 of the parts 34a and 34b of the armature 34 and pivots slightly, which pulls on the screws 65 lifting the head 64 thereof. The screws 65 make the yokes 31 move back and move away from the brake disc, against the action of the springs 38.

The openings 62 do not prevent the plate 61 from pivoting, due to the fact that they are open in the opposite direction to the lever 60.

The armature bears plugs 70, which may be seen in particular in FIG. 1, which are accessible through the corresponding openings 73 of the armature 34. These plugs 70 face yoke housings 75, made up by blind holes, which may receive compression additional springs which increase the braking torque. It is possible to add these springs without dismantling the brake, by removing the plugs 70, introducing the springs, then refitting the plugs 70. The springs then bear against the plugs 70.

In the example of FIGS. 1 to 4, the two brake units 30 share the same armature 34, the latter being produced as a single casting for example.

It is possible to produce each brake unit 30 with a separate armature 34 thereof, as illustrated in FIGS. 5 and 6.

In this case, each brake unit 30 may be fitted and removed independently of the other unit.

These figures show the casing 7 of the motor on which the brake is fixed, as well as the brake disc 20 which bears the brake linings 21 and 22.

FIGS. 5 and 6 do not show the unlocking lever, but it may be the same as the lever 60 of the example in FIGS. 1 to 4.

The invention is not limited to the examples which have just been described.

The brake may be produced with more than two brake units or, in an alternative, with a single unit. In this case, the yoke has an annular shape for example.

1-16. (canceled)

17. A brake for a rotary electric machine including a rotor having a shaft, the brake including:
at least one fixed armature,
at least one yoke mobile between a position for braking the shaft of the machine and a position for free rotation of the shaft,
at least one winding borne by the yoke,
at least one brake disc borne by the rotor shaft,
at least one elastic return system for applying the yoke against the brake disc in the absence of electrical excitation of the winding, the armature being placed such that the excitation of the winding causes the yoke to draw closer to the armature and moves the yoke away from the brake disc.

18. The brake as claimed in claim 17, the elastic return system being inserted between the armature and the yoke.

19. The brake as claimed in claim 17, the yoke being open in the direction of the armature.

20. The brake as claimed in claim 17, including an operating lever for acting on the yoke through the armature.

21. The brake as claimed in claim 20, the operating lever being engaged under at least one screw head fixed on the yoke and jutting out from the armature in the opposite direction to the casing of the motor.

22. The brake as claimed in claim 17, the armature substantially having the same outer contour as the yoke.

23. The brake as claimed in claim 17, the armature or the yoke having a substantially polygonal contour.

24. The brake as claimed in claim 17, the winding having an elongated shape.

25. The brake as claimed in claim 17, the yoke being a casting.

26. The brake as claimed in claim 17, wherein damping elements are inserted between the yoke and the casing on the one hand, and the yoke and the armature on the other hand.

27. The brake as claimed in claim 26, the damping elements being made up by rings made from an elastically deformable material.

28. The brake as claimed in claim 17, the armature bearing removable plugs which face housings of the yoke.

29. The brake as claimed in claim 28, the removable plugs receiving compression additional springs for increasing the braking torque.

30. The brake as claimed in claim 29, the additional springs being fitted without dismantling the brake.

31. A rotary electric machine including at least one brake as defined in claim 17.

32. The machine as claimed in claim 31, including at least two identical brake units placed on either side of the axis of the rotor.

33. The machine as claimed in claim 31, the armature being fixed to the casing of the machine by screws and struts between which or on which the yoke moves.

34. The machine as claimed in claim 31, the rotor driving a winch or a pulley.

35. The machine as claimed in claim 31, the brake disc being axially mobile on the shaft of the machine.
